(19) United States
(12) Patent Application Publication
(10) Pub. No.: US 2020/0055759 A1
(43) Pub. Date: Feb. 20, 2020

(54) Method for Disinfecting and Cleaning Liquid Media and Method for Separating Solid and Liquid Constituents of a Solid-Liquid Mixture and Apparatus for Implementing the Method

(71) Applicants: Alfons Schulze Isfort, Altenberge (DE); Dominik Schulze Isfort, Altenberge (DE); Frieda Tauber, Greven (DE); Otto Tauber, Greven (DE)

(72) Inventors: Alfons Schulze Isfort, Altenberge (DE); Dominik Schulze Isfort, Altenberge (DE); Frieda Tauber, Greven (DE); Otto Tauber, Greven (DE)

(21) Appl. No.: 16/461,429

(22) PCT Filed: Sep. 19, 2017
(86) PCT No.: PCT/EP2017/001102

§ 371 Date: Oct. 5, 2019

Related U.S. Application Data
(63) Continuation-in-part of application No. PCT/EP2016/001908, filed on Nov. 16, 2016.

(51) Int. Cl. C02F 9/00

(52) U.S. Cl. CPC C02F 9/00; C02F 1/36

(57) ABSTRACT

The invention relates to a method for cleaning and/or disinfecting liquid and/or aqueous media, comprising the following method steps: cavitation treatment of the medium, in particular by means of jet cavitation, at a negative pressure <1 bar, preferably 0.3 to 0.7 bar; subsequent treatment of the medium in a hydrodynamic reactor having a a rotating magnetic field and magnetic and/or magnetisable elements, in particular having ferromagnetic needles or a rotating cutting mechanism at a negative pressure <1 bar, preferably 0.3 to 0.7 bar; subsequent separation, in particular sedimentation of the treated medium by means of sludge separation at a negative pressure of <1 bar, preferably 0.3 to 0.7 bar. The invention further relates to an apparatus having the following features: a cavitator formed in particular as a jet cavitator, which is equipped with a negative pressure generator, a hydrodynamic reactor having a rotating magnetic field and magnetic and/or magnetisable elements, in particular having ferromagnetic needles and/or a rotating cutting mechanism, a unit for separation, in particular for sedimentation, preferably combined with a sludge separation apparatus.

The invention concerns a method for disinfecting and cleaning liquid and/or aqueous media, namely initially a method and an apparatus for cleaning and in particular disinfecting the medium and can be employed for water processing, in systems for drinking and household water, process water, in the chemical and pharmaceutical industry, in the food industry, in the medical industry as well as for cleaning and disinfecting wastewater of municipal operations, industry, in agricultural operations, local water purification plants, modular water processing stations, but in particular also as a downstream method of method that beforehand has been performed for separation of solid and liquid components of a solid-liquid mixture, for example, in order to aftertreat liquid components that have accumulated in a method in which solid and liquid components of a solid-liquid mixture have been separated, for example, in the treatment of manure, warfare disposal substances, and the like.

Numerous processing techniques for multi-stage cleaning processes of liquid media such as e.g. water correspond to the current technical standard. The employed processing techniques and plants concern e.g. a chemical water disinfection, such as e.g. a water treatment with chlorine by means of special chlorine facilities where the processed chlorine water is subsequently mixed with the complete incoming water quantity. A disadvantage of water treatment with chlorine resides in that chlorine for the application must be stored in steel bottles in intermediate stores which causes high investment costs. Water processing plants cannot prevent the ingress of significant quantities of inorganic and organic substances into the drinking water. Under these conditions, the broad use of chlorine as disinfecting agent leads to the formation of new compounds that are often more toxic than the starting substances. It is known that halogen-containing compounds are produced in the water treatment with chlorine and most of them are mutagenic and some, as cancer-causing substances, constitute a danger to humankind. The chlorination of phenol-containing water enhances e.g. the water odor due to the formation of chlorophenols whose threshold concentration is thousand times higher than that of the actual phenol.

The most commonly used strong oxidation and disinfecting agents are molecular chlorine and its modifications, hypochlorides, chloroammonium (B. Sostmann “Organoleptische Prüfung von Wasser”, M.: Chemie, 1984).

A method for treatment of water and water solutions is known which provides a pH correction by a multi-stage pressure drop in a high-pressure liquid wherein its return flow reaches the value at which the cavitation begins with subsequent pressure increase to the value at which the cavitation ends. Subsequently, the circulating liquid is preheated, then a portion of the high-pressure liquid is removed for a filtration, and the cavitated liquid is removed with pressure increase from the residual circulation flow, cooled, and put down until the cavitation bubbles implode and the resulting solid materials have precipitated. Subsequently, the stabilized liquid is returned to the low-pressure circulation flow. In doing so, the pressure of the cavitating liquid is brought to air pressure values or higher. The energy which is recovered from cooling the flow is utilized as heat carrier for household and processing demand purposes. The cavitation is performed with hydrodynamic methods or ultrasound methods. The implosion of bubbles is realized by cooling the cavitated liquid by feed flow and/or cold flow of the heat carrier. The filtered solid materials are rinsed with the flow from the liquid that is removed for filtration (patent RU 2240984 dated Nov. 27, 2004).

The disadvantages of this technical solution include a low disinfection efficiency that is required for drinking water. Furthermore, it is impossible to remove organic substances. The realization of the method as disclosed therein therefore appears doubtful whether it can be realized at all.

Furthermore, a method for water procurement from natural resources is known in which water of an open body of water is first purified in a prefilter and subsequently is ultra-filtered in a coarse filter. The aftertreatment until the water has the quality of drinking water is realized by reverse osmosis. After sorption on carbon, the drinking water is subjected consequently to the cation and anion exchange. Subsequently, the water is sterilized in a candle filter with pore size of 0.2 μm. In doing so, the water quality is continuously tested according to values of a specific electrical resistance (patent RU 2258045 dated Aug. 10, 2005).

The plant for realizing the commonly used method is comprised of a coarse filter, a prefilter, a pump, a supply line, an ultrafilter, a high-pressure pump, a reverse osmosis filter, resistance measuring devices, a carbon filter, a sorption filter, a cation filter, an ion filter as well as a candle filter for the sterilization.

A disadvantage of this method and of the plant for carrying it out resides in that no pre-oxidation is provided in order to convert soluble iron to hydroxide in order to prevent its penetration into the microfilters. Iron ions in the microfilter, their frequent regeneration or an exchange disturb the continuous operation of the membrane unit, increase maintenance costs and production costs of the drinking water production. Harmful substances collect in carbon filters, sorption filters, and at the candle filter. They must be regularly flushed away with chemical reagents.

The prior art discloses an apparatus for disinfecting wastewater and natural water (patent RU 2328450 dated Jul. 10, 2008) that is comprised of five stages of which each comprises a container and a hydrodynamic cavitator. Each hydrodynamic cavitator is embodied in the form of a rotating cavitator with a suction socket and a pressure socket. The container of the first stage is connected to the suction socket of the cavitator whose pressure socket is connected to the container of the second stage. The cavitator of the second stage is connected to the sockets of the containers of the second and third stage. The cavitator of the third stage is connected to the sockets of containers of the third and fourth stage. The cavitator of the fourth stage is connected with the sockets of containers of the fourth and fifth stage. The cavitator of the fifth stage is connected of containers of the fifth stage and the apparatus for water purification. Bottom parts of the containers of the fourth and fifth stage are connected by pipelines with the apparatus for discharging sediment into the sewage system.

A disadvantage of this method resides in that functional components of the same type are used, i.e., rotating cavitators, that cannot provide some necessary factors of neutralization and cleaning processes such as a mechanical shock processing, electrolysis processes, and so on.

In the prior art, moreover a method for cleaning liquid media is known which encompasses an equalization of the medium composition, a cavitation treatment of the medium, a treatment of the medium in the magnetic field, a pH correction of the medium as well as a sedimentation about a purification of the medium (patent application RU 2002119765).

Moreover, the prior art discloses a method and an apparatus for treatment of liquid media by jet cavitation (RU utility model 54662 dated Jul. 10, 2006).

Moreover, a method for treatment by means of a rotating impulse device is known (patent RU 2304561 dated Aug. 20, 2007).

The disadvantage of the aforementioned methods and treatment plants resides in that they cannot ensure a high cleaning performance and high efficiency.

In the context of the present invention, the mentioned technical result is achieved by variants of the method as follows:
The treatment with jet cavitation and in the ferromagnetic stator is performed with formation of strong oxidation agents OH+, H₂O₂, and O₃, namely respectively at a vacuum of <1 bar, preferably 0.3 to 0.7 bar;
Optional treatment in the ferromagnetic stator with dispersion of particles to submicron dimensions and enlargement of the phase boundary surface gas-liquid-solid and again at a vacuum of <1 bar, preferably 0.3 to 0.7 bar;
Prior to the cavitation treatment, optionally an equalization of the aqueous medium is carried out;
In the course of the hydrodynamic treatment, optionally at least one reagent is supplied to the ferromagnetic stator. The reagent can be selected e.g. from the following group: lime milk, aluminum sulfate, iron chloride and this is done at a vacuum of <1 bar, preferably 0.3 to 0.7 bar;
The method can comprise a treatment of the obtained medium in a rotating impulse device and again at a vacuum of <1 bar, preferably 0.3 to 0.7 bar;
The method can optionally comprise a filtration of the medium by means of a deep-bed filter and again at a vacuum of <1 bar, preferably 0.3 to 0.7 bar;
The method can optionally comprise an ozone treatment of the medium at <1 bar, preferably 0.3 to 0.7 bar;
The method can optionally comprise a treatment of the medium with UV radiation at a vacuum of <1 bar, preferably 0.3 to 0.7 bar;
The method can comprise a sedimentation aftertreatment in e.g. a multistage cascade of sedimentation containers and again at a vacuum of <1 bar, preferably 0.3 to 0.7 bar.

The aforementioned technical result is achieved upon realization of the described method for cleaning and disinfecting of aqueous media in particular in that in the realization of the method the following apparatus units are used: a cavitator, in particular a jet cavitator, at a vacuum of <1 bar, preferably 0.3 to 0.7 bar, with a ferromagnetic stator with a magnetic rotary field and a magnetic and/or a magnetizable element, in particular with magnetic and ferromagnetic needles or a rotating cutting mechanism, and preferably with a unit for a sedimentation, in particular a separating facility and in particular a downstream sludge separating unit which is also operated at a vacuum of <1 bar, preferably 0.3 to 0.7 bar.

Moreover, the aforementioned technical result is achieved in individual realization variants of the apparatus in that the apparatus can be provided optionally with an equalization mixer which is installed in flow direction of the media to be disinfected upstream of the jet cavitator. Moreover, the apparatus can be optionally provided with a unit for metering reagents into the ferromagnetic stator. Moreover, the separating apparatus of the medium can be embodied preferably as hydrocyclone. Moreover, the apparatus or plant can be provided with a rotating impulse device which in flow direction of the media is installed downstream of the separating apparatus. The apparatus is preferably furnished with deep-bed filters which are installed in flow direction downstream of the separating unit. Moreover, the apparatus can be embodied preferably in a unit for ozone treatment of the medium which in flow direction is installed downstream of the separating apparatus. Moreover, the apparatus is preferably furnished with a unit for UV radiation of the medium which in flow direction is installed downstream of the separating unit. Moreover, an automatic control unit can be provided in order to adjust and to control the entire apparatus and thus the processing line automatically.

In contrast to known analog plants, the method according to the invention and the plant suitable for realizing the method employs a combination of a cavitator, in particular of a jet cavitator, with a plant that is furnished of a vacuum and a downstream ferromagnetic stator (FMS) with magnetic rotary field and magnetic and/or magnetizable elements, in particular with ferromagnetic needles.

It has been found unexpectedly that the cavitation treatment at a negative pressure of <1 bar, preferably 0.3 to 0.7 bar, in the cavitator and subsequent cavitation treatment of the medium in a ferromagnetic stator (FMS) that in a mechanical cutting mechanism significantly increases the performance and efficiency of the cleaning action. This is in particular the result of the following:

In a conventional treatment of wastewater with a jet cavitator, the cavitation region L is formed. Within this cavitation region L, the molecule decomposition, the radical formation and the bubble implosion take place. After having passed this cavitation region L, the liquid flow begins to stabilize which means that the reaction of ozone treatment, water decomposition and others are beginning to reverse and reach an equalized value. The service life of the strongest oxidation agent OH radical amounts to approximately 100_{NS}. This means that after passing this region L no radical OH is present in chemical reactions anymore. Accordingly, the processes for treatment of the liquid in the jet cavitator and in the FMS are divided temporally and represent individual processes standing on their own.

Due to the negative vacuum larger cavities are produced, in particular supercaverns, a cavitation range that is characterized by hundred times the lengths L1 (for identical conduit cross sections). In the end, the cavitation number in particular drops to a stable supercavitation operation. These cavities and in particular a supercavern result in water decomposition products, radicals, cavitation seeds, and form these immediately in the working region of the FMS for reduction-oxidation reactions, displacement reactions, and other reactions which occur on giant phase boundary surfaces GLS (gas-liquid-solid) which are generated in the working region of the FMS. Therefore, in the working region of the FMS, cavitation processes, the formation of strong oxidation agents, interactions between oxidation agents and decomposed liquid compounds occur at the same time on phase boundary surfaces that are enlarged multiple times, which increases the reaction rate multiple times and ensures, by the comminution of solid materials to the submicron range and the enlargement of phase boundary surfaces, a complete interaction between all elements participating in reaction. Accordingly, the general efficiency of displacement, sedimentation, oxidation, and other processes increases which significantly improves the cleaning quality. In doing so, the speed of the subsequent separation, in particular a sludge sedimentation, is ensured.

In the ferromagnetic stator, reagents, for example, lime, can be used additionally for accelerating reactions. Moreover, the medium downstream of the separating unit can be subjected to aftercleaning and after disinfection by means of a rotating impulse device, of a deep-bed filter, of an ozone treatment unit and/or of a UV treatment unit.

A general plant or apparatus for realizing the described method comprises in sequence an equalizing mixer, a flow-through jet cavitator, a vacuum generator, a ferromagnetic stator with rotating ferromagnetic elements (with magnetic rotary field), combined with a metering unit for adding reagents, a unit for sedimentation, furnished e.g. with hydrocyclones and a sludge separating unit, a rotating impulse device (cavitator), a deep-bed filter unit with automated filling regeneration, an ozone treatment unit, a UV irradiation unit, and a unit for supply of processed water. Moreover, an automatic control unit can be provided which is linked with all units of the plant. Further units are installed as needed in order to provide fine purification, e.g. in order to obtain drinking water.

The equalization meter is provided for the equalization of the composition of the liquid medium and represents a container with a mixer. The jet cavitator is provided for treatment of the liquid medium. A jet cavitator is comprised in general of a tubular housing with a narrowed part and a rearward expanded part as well as with a socket for applying the vacuum. A ferromagnetic stator (FMS) is provided for the cavitation treatment of the medium in order to accelerate the oxidation and the decomposition of molecules of the organic substances that are dissolved in water. The FMS utilizes the energy of the magnetic rotary field with a high specific concentration in a space of the working region. The FMS comprises a housing with a working region where an exchangeable insert and ferromagnetic elements (needles) as well as an inductor are located which extends across the entire working region. In this context, the inlet of the FMS is connected immediately with the outlet of the cavitator. The unit for sedimentation which is provided with a sludge separating unit is provided for the separation of the liquid medium and the sludge which accumulates as a result of the preceding treatment.

A rotating impulse device is provided for the subsequent removal of suspended particles from the purified medium. It represents a horizontal cylinder-shaped hollow housing which has two diametrically opposed threaded bores in which the nozzles are arranged whose mouth is embodied to be flush with the cylindrical interior cavity. The cylindrical hollow housing has also a cylindrical hollow rotor which is coaxially installed with gap. The cylindrical hollow rotor has two diametrically opposed identical openings. In this context, identical mouth openings of the nozzles and two identical openings of the rotor are provided on a diametrical axis. The rotor is provided with a bearing unit which is furnished with a sleeve for sealing the housing interior of the hydrodynamic impulse generator upon rotation of the rotor by an electric drive. Deep-bed filter units, ozone treatment units, and the UV irradiation unit ensure a final fine purification of the corresponding medium.

In the following, the realization of the method according to the invention by means of the afore described plant will be described based on the example of wastewater cleaning.

Wastewater, via of equalization mixtures, with a speed of 28 to 33 m/s is introduced into the continuous cavitator where the cavitation treatment of wastewater is performed. In this context, a vacuum of <1 bar, preferably 0.3 to 0.7 bar, is applied to the continuous cavitator. In this way, a supercavern is produced and its main footprint is enlarged. Thus, the cavitation process passes into the phase of the ventilation cavitation (artificial cavitation) that is characterized by a drop in the cavitation number (stable supercavitation operation). Upon an implosion of microbubbles, cumulative microjets at speeds of 200 to 1,000 m/s and a local shockwave pressure of approximately 10³ MPa is produced which act on reaction components in spacings that are comparable to molecule dimensions. Moreover, fungal and bacterial spores are quickly killed upon collision of impulse jets.

A required prerequisite for a bubble implosion is the movement and the excitation of the medium which leads to a bubble implosion of spherical symmetry. A very high speed at the time of the implosion and a strong increase of local pressure are considered one of the reasons for the generation of the cavitation. It is known that an appearance of vapor formation and air expulsion is referred to as cavitation which is caused in the liquid by lowering the pressure. The cause for cavitation is screening of a liquid at normal temperature under low pressure. The generation of the cavitation is enabled by the air dissolved in the water which discharges when the pressure drops. The life cycle of a cavitation bubble is comprised of two phases: The expansion and the implosion which together form a complete thermodynamic circuit. In the pressure ready the hydrostatic pressure drops so that the forces acting liquid molecules become greater than the molecular binding forces. Because of the quick change of the hydrostatic balance, the liquid basically explodes whereby a plurality of smallest bubbles are generated. The cavitation is produced earlier the more the liquid is “soiled” with solid materials or other foreign bodies (e.g. bacteria), the higher its temperature.

“Boiling” of a liquid is caused in that a thin air layer is adsorbed on the surfaces of these particles. The air layer particles enable the development of such a cavitation when they reach the vacuum region.

The bacterial flora in the liquid to be treated serves also as a point of origin for cavitation bubbles. When the liquid reaches the vacuum ready, it begins to boil and cell membranes of bacteria that reach the center or the vicinity of produced cavitation bubbles are completely or partially destroyed due to the pressure difference in the interior and in the ambient.

The second phase of the life cycle of a cavitation bubble is the implosion (condensation). It occurs in a pressure region into which the cavitation bubble passes with the liquid to be treated. The condensation process of a cavitation bubble is instantaneous. The liquid particles which surround the bubble migrate at high speed to its center.

In the end, the movement energy of particles at the moment of combination of bubbles causes local hydraulic microshocks which are accompanied by local pressure increase up to 10⁴ kg/cm² and by local temperature increase up to 1,000 to 1,500° C. During the course of the hydrodynamic cavitation at high speeds of the working media in the cavitators of 28 to 33 m/s, most cavitation bubbles are deformed and are of elliptical or conical shape. Upon implosion of such bubbles, cumulative jets with high energy are produced that destroy anything in their path. The implosion of individual cavitation bubbles does not show an expected effect. However, a plurality of cavitation bubbles are present and per second several thousands thereof implode. Therefore, they can exert as a whole a significant destructive or other effect without high-temperature heating of the liquid to be treated. Accordingly, the cavitation in the ultrahigh temperature operation in addition to the mechanical effect also provides a microsterilization effect on the bacterial flora in the zone of the extinction of cavitation bubbles. The walls of cavitation bubbles and of liquid drops which are contained in bubbles have oppositely poled charges. Upon implosion, the bubbles shrink drastically and the charges come to very small surfaces of the bubbles. By a sudden decrease of surfaces of the cavitation bubbles, the voltage of static electricity increases gravely. Between the walls of cavitation bubbles and drops contained therein, electrical discharges occur which have a form of microscopic flashes. These electrical discharges with high strength act also in a damaging way on the bacteria that have caused generation of the aforementioned bubbles.

A high temperature and a high pressure which are generated in the zones of extinction of cavitation bubbles as well as microflashes of static electricity effect the water decomposition course.

A generation of the cavitation at surfaces of bacteria which are surrounded with adsorbed air is accompanied by a formation of free radicals OH, HO₂, N as well as of N products of their recombination H₂O₂, HNO₂, HNO₃. The formation of hydroperoxide, free radicals and acids has a deadly effect on the bacterial flora of the liquid to be treated.

With a liquid flow, the gas-air phase that contains a large quantity of gas and non-imploded bubbles as well as nucleons (cavitation seeds) is transferred into the working region of the FMS. In the working region of the FMS, a comminution of solid materials which are contained in the wastewater takes places to submicron dimensions as well as molecule decomposition under impact action of ferromagnetic elements in the magnetic rotary field. Further cavitation effects are produced and electrolysis processes occur.

Under the effect of the electromagnetic field, the ferromagnetic elements rotate about their transverse axis in the working region of the FMS at a speed which comes close to the rotary speed of the magnetic field in order to migrate at the same time within the working region. Also, the particles vibrate relative to the force vector of the magnetic field. These vibrations can amount to several thousands per second. Accordingly, each ferromagnetic element represents its own mixing mill which rotates at a high but alternating rotary speed. Such a movement of hundreds of particles leads to a fast mixing and dispersion of components. The specific energy of the electromagnetic rotary field is extremely high and reaches 10 kW/m³. The energy intensity of the FMS is e.g. 100 to 200 times higher in comparison to the energy intensity of vibration mills.

In this way, a highly dispersed heterogeneous system G-L-S (gas-liquid-solid) in the working region of the FMS is formed which reacts at a high speed with radical OH, H₂O₂, O₃ and even with atomic oxygen. An acceleration of the speed of the chemical reaction is caused by the multiple enlargement of contact surfaces of the phases at the boundaries at the G-L-S.

For accelerating the separation of solid materials (heavy metals) and for additional disinfection of wastewater, reagents are supplied to the FMS by means of a metering unit, e.g. lime milk, aluminum sulfate, iron chloride (depending on the original composition of the wastewater).

Since the reagents are introduced immediately into the working region of the FMS and are comminuted together with solid materials from wastewater, they enter immediately into the precipitation reaction and into the displacement reaction with heavy metals. Conversion processes of hexavalent chromium to trivalent chromium and subsequently to chromium hydroxide (heavy metals Zn, Fe, Cu) which are contained in the wastewater in the working region of the FMS, are converted into insoluble hydroxides Fe(OH)₃, ZN(OH)₂ and Cu(OH)₂ under the effect of lime milk. Organic substances are decomposed to complete mineralization (to CO2 and H2O). The processed wastewater is introduced in the unit with hydrocyclones where an accelerated sedimentation of coagulated particles is realized. Sludge is removed by the sludge removing system.

If a fine cleaning action is needed, the purified water flows through the rotating impulse device (cavitator) or through a flotation unit for removal of suspended particles, namely through the deep-bed filtration unit, the ozone treatment unit, and the UV irradiation unit for disinfecting the water in accordance with the specifications of the customer in regard to final values for the processed water. In this context, all devices and units are controlled by an automatic control unit.

In the following, examples for the realization of the method according to the invention will be described.

### EXAMPLE NO. 1

The purification of wastewater from a slaughterhouse was performed in a device with an output of 5 m³/hour according to the afore described method. In Table 1, the results of a quantitative chemical analysis (QCA) of water prior to and after the treatment are listed as well as the cleaning efficiency in relation to permissible limit values (BGW values).

| | | QCA | QCA | |
|---|---|---|---|---|
| | | starting | processed | cleaning |
| No. | description of value | water | water | efficiency, % |
| 1 | pH value | 6.58 | 8.75 | BGW standard |
| 2 | suspended particles, | 47 | 25.0 | BGW standard |
| | mg/dm³ | | | |
| 3 | phosphates, mg/dm³ | 4.50 | 0.15 | 96.6 |
| 4 | phosphates (based | 1.49 | 0.04 | 97.3 |
| | on phosphorus), | | | |
| | mg/dm³ | | | |
| 5 | hydrocarbonate, | 436.29 | 369.17 | BGW standard |
| | mg/dm³ | | | |
| 6 | chloride ion, mg/dm³ | 221.3 | 73.2 | 67 |
| | ** | | | |
| 7 | ammonium ion, | 70.87 | 11.24 | 84 |
| | mg/dm³ | | | |
| 8 | ammonium ion | 55.28 | 8.77 | 84 |
| | (based on nitrogen), | | | |
| | mg/dm³ | | | |
| 9 | nitrite ion, mg/dm³ | <0.02 | 0.134 | BGW standard |
| 10 | nitrate ion, mg/dm³ | <0.10 | <0.10 | BGW standard |
| 11 | CSB, mgO/dm³ | 790.0 | 184.0 | 77 |
| 12 | fluoride ion, mg/dm³ | 0.29 | 0.26 | BGW standard |
| 13 | phenols, mg/dm³ | 0.128 | 0.037 | 71 |
| 14 | total iron, mg/dm³ | 12.937 | 0.103 | 99.2 |
| 15 | total chromium, | <0.005 | <0.005 | BGW standard |
| | mg/dm³ | | | |
| 16 | copper, mg/dm³ | 0.013 | 0.005 | BGW standard |
| 17 | zinc, mg/dm³ | 0.019 | 0.004 | 79 |
| 18 | nickel, mg/dm³ ** | 0.027 | 0.006 | 78 |
| 19 | anionic surfactants, | 0.10 | 0.06 | BGW standard |
| | mg/dm³ | | | |
| 20 | mineral oil products, | 0.34 | 0.07 | 79 |
| | mg/dm³ | | | |
| 21 | fats, mg/dm³ ** | 12 | 0.145 | 98.8 |
| 22 | lead, mg/dm³ | <0.002 | <0.002 | BGW standard |
| 23 | formaldehyde, | 0.035 | 0.01 | 71.4 |
| | mg/dm³ ** | | | |
| 24 | methanol, mg/dm³ ** | 0.361 | 0.1 | BGW standard |
| 25 | chloroform, mg/dm³ | 0.08 | 0.01 | 87.5 |
| | ** | | | |
| 26 | calcium, mg/dm³ | 90.7 | 20.67 | BGW standard |
| 27 | barium, mg/dm³ | 0.075 | <0.05 | BGW standard |
| 28 | potassium, mg/dm³ | 48.7 | 4.35 | 91.1 |
| 29 | sodium, mg/dm³ | 108 | 95 | BGW standard |
| 30 | lithium, mg/dm³ | 0.06 | <0.015 | 75 |
| 31 | magnesium, mg/dm³ | 23.0 | 0.25 | 98.9 |
| 32 | strontium, mg/dm³ | 1.46 | 0.38 | 74 |

### EXAMPLE NO. 2

The neutralization of wastewater of hog houses in a processing line with output of 5 m³/hour according to the above-described method was performed. In Table 2, the water values prior to and after treatment are listed.

| value | prior to treatment | after treatment |
|---|---|---|
| total number of microbes, | 4 · 10⁷ | without findings |
| m. t/ml | | |
| worm egg content, | 3 · 10⁴ | without findings |
| pc./dm³ | | |

Accordingly, the disclosed method and the processing line by intensifying processes which are carried out in the cavitator, FMS, and separator, enable a significant increase of the cleaning performance as well as increase of efficient of cleaning and disinfecting of liquid media.

Even though the method in question and the processing line are described based on the example of wastewater purification, they can also be used for disinfecting and cleaning of other liquid media. For example, the afore described method can be applied downstream of a method in which solid materials and liquids are separated from a solid-liquid mixture in order to further treat the separated liquid.

In the upstream method, the solid-liquid mixture is separated in a housing with a vibration screen. In the housing such a vacuum is existing above the vibration screen and below the vibration screen so that with the adjusted pressure reference with a pressure gradient in the direction toward the space below the vibration screen of the solid-liquid mixture with the adjusted vibrations during the separation process can be maintained in a kind of floating state above the screen surface so that by the impulses from the vibration conveying device this state can be adjusted with conveying direction in the direction toward the slightly ascending vibration screen.

Due to the existing pressure conditions, air flows through the material to be separated with entrainment of liquid particles. An air flow can also pass below the floating cake to be separated (solid-liquid mixture) through the meshes of the screen surface with entrainment of corresponding liquid proportions so that the separation process is realized with an extremely high processing speed and the vibration screen is permanently cleaned.

In this context, it is expedient when during the course of the further conveyance of the solid-liquid mixture a break edge within the screen surface is provided so that the latter is divided into at least two vibration screen regions, namely in such a way that by the stepped configuration in conveying direction a lower vibration screen surface is provided with the result that the liquid-solid materials that have been further transported can be turned over by an overhead movement and the side of the cake to be separated conveyed at the top up to this point comes to rest on the prior top side with a corresponding impulse whereby the separation process is further promoted.

By a pressure compensation between the space below the vibration screen and the space above the vibration screen that occurs automatically and, for example, can be adjusted by a flexible seal, for example, a flexible rubber lip, it is also ensured that no settling of the material to be separated at the top screen surface occurs because in this case an automatic pressure compensation is realized upon initial settling. In this way, extremely high performance data with the method according to the invention and with the apparatus according to the invention can be achieved.

Due to such excellent performance data, the method according to the invention and the apparatus according to the invention have been found to be particularly suitable for a plurality of different fields of application, for example, for the
chemical industry
including petrochemical industry
ores, minerals
alumina industry
coal industry
energy industry
engineering/plant construction
food industry, e.g., processing of slaughterhouse waste
beverage industry
healthcare
disaster aid
pharmaceutical industry
agriculture, e.g. for processing manure
or for municipal applications, e.g. processing of sewage sludges
electricity production from peat
production of organic fertilizer
conversion of biomass into carbon products
general biomass processing

Advantageously, it can be provided that the inlet through which the solid-liquid mixture is supplied to the vibration screen opens above the rear end of the vibration screen in the conveying direction. The solid components contained in the solid-liquid mixture reach the vibration screen in the region of its rearward end so that they are conveyed across the entire length of the vibration screen until they reach the leading end where the outlet opening is provided. The movement of the solid components across the length of the vibration screen promotes the separation of the liquid components from the solid components and increases thus the degree of separation.

Advantageously, below the inlet and above the vibration screen, a distributor can be arranged in the housing. This distributor serves to utilize the surface of the vibration screen optimally for separation. The distributor does not act in longitudinal direction or conveying direction of the vibration screen but transverse thereto, distributes the mixture thus across the width of the vibration screen and advantageously across its entire width.

Advantageously, the vibration screen can be arranged at a slant from bottom to top and can be operated such that it conveys the solid components at a slant upwardly. In adaptation to the intended field of application, the gradient of the slanted position can be constructively predetermined or a slant adjustment of the vibration screen or of the housing can be provided in order to be able to adapt the apparatus flexibly to different requirements.

It can be particularly advantageously provided to adjust within the housing in which the vibration screen is located the level of the solid-liquid mixture only so high that the vibration screen partially projects past this level in upward direction. Already within the solid-liquid mixture supplied onto the vibration screen, a type of floating filter cake with a high solid contents is formed on the vibration screen. This filter cake is conveyed upwardly on the vibration screen and thus above the level of the solid-liquid mixture so that thereat, enhanced by the shaking effect of the vibration screen, a particularly effective further separation of the liquid components from the filter cake can be realized prior to the solid components then reaching the discharge opening through which they exit the housing.

In practical tests, a mesh width of the vibration screen has been found suitable that is smaller than 0.8 μm, for example, amounts to between 0.7 and 0.8 μm. With such mesh widths, high throughput capacities of the apparatus have been effected in regard to separating manure. While the proportion of solid components within the solid-liquid mixture amounted to approximately 7 to 8%, it amounted to only approximately 0.8% in the liquid components exiting from the device.

By means of an even smaller mesh width of, for example, approximately 0.4 to 0.5 μm, the degree of separation can be increased even more and, for the same starting material, the quantity of solid components can be reduced to approximately 0.2 to 0.3% while accepting a reduced throughput capacity of the apparatus.

The degree of separation can be even more improved when the solid components exiting from the discharge opening are aftertreated in a subsequent second separation step, for example, in a screw press. A particularly advantageous embodiment of a screw press resides in that, in a generally known way, it comprises a screw, which is referred to as pressing screw or screw conveyor, and that comprises radially outside of the screw one or several filters. This aftertreatment can also be carried out under vacuum, as advantageously in claim 1 and according to claims 2 and 3. The particular advantageous embodiment resides in that this filter comprises a plurality of slots that extend in the longitudinal direction of the screw. Liquid components that exit from the material must therefore not flow transverse to the conveying direction of the screw radially outwardly in a kind of directional change of approximately 90° but, due to the slots extending in longitudinal direction, they can pass, little by little, farther outwardly in radial direction and through the slots with only minimal directional change across the entire length of the screw. In this way, not only the operation of the screw press with a surprisingly minimal drive output is possible but also excellent results are obtained in regard to increasing the dry proportion in the material. The configuration of the described screw press can advantageously comprise a filter that has a plurality of flat irons. These flat irons are coaxially oriented relative to the screw in that the flat irons extend with their length in the longitudinal direction of the screw. In regard to the material cross section of the flat irons, they are oriented like a circle of rays about the screw so that the width of the flat irons extends radially away from the screw in outward direction and the material size or thickness of the flat irons extends in tangential direction relative to the screw. Due to this circle-of-rays-type orientation of the flat irons, they are contacting each other with their radial inner ends almost seal-tightly while in outward direction the spacings of the flat irons relative to each other become larger. Even when the individual flat irons are contacting each other presumably without a gap and form a pipe that apparently encloses the screw seal-tightly and that shows gaps only at its radial outer surface, the pressing pressure of the screw is sufficient to drive moisture that is still contained in the material through the minimal gaps between the flat irons and to improve in this way the degree of separation and to reduce further the moisture contents in the solid components.

In comparison to providing, for example, a pipe wall with a plurality of fine slots, a configuration of this filter that is constructively as simple as possible and economically producible can reside in that, for example, several flat irons are combined to a package, respectively, for example, depending on their thickness two to ten flat irons contacting each other. Despite a full surface contact of the individual flat irons on each other, passage possibilities for the liquid to be discharged are provided for a sufficiently high inner pressure within the filter. Between two neighboring packages in the outer radial region of the filter, spacers are provided but not within the radial inner region of the filter in order to provide in this way an annular and almost circle-shaped cross section of the filter which surrounds the pressing screw like a polygonal pipe. The screw press can be used for separation even independent of the proposed apparatus that comprises a vibration screen operated with suction.

Advantageously, a conveying device can be provided which conveys the solid components, that either reach directly from the housing accommodating the vibration screen or indirectly, i.e., from the downstream second separation stage, to a transfer point. The conveying device can be designed in many different ways, for example, as a belt conveyor or screw conveyor wherein in the following—purely as an example—a screw conveyor is mentioned. At this transfer point, the solid components are transferred from the apparatus to a downstream facility The downstream facility can be, for example, an open storage site or a container into which the solid components are introduced. When they are placed as a pile onto the ground or filled into a container, the solid components have a significant temperature level even after several days, possibly due to composting processes. The solid components can therefore be placed, for example, into a container that contains a pipe heat exchanger so that a medium passed through this heat exchanger can be heated.

Advantageously, the proposed apparatus is embodied as a mobile transportable unit, for example, can be constructed within a container, on a vehicle trailer or the like. In practical applications it has been surprisingly found that, due to the high throughput capacity, the contents of a complete manure tank, as it can be found in agricultural operations, can be separated within a few hours. In this context, a feed line from the manure tank to the device is laid, through which the manure from the manure tank is supplied to the apparatus, namely to the housing which encloses the vibration screen. In this feed line a pump is advantageously provided which conveys the solid-liquid mixture into the housing.

The aforementioned suction pump conveys in turn the liquid components back into the manure tank and provides for the vacuum below the vibration screen. With this recirculation, it is not required to provide an additional tank as an intermediate storage into which the separated liquid components of the manure exiting from the apparatus are conveyed. Instead, due to the recirculation of the manure or of its liquid components, the proportion of solid components in the manure container is significantly reduced little by little so that after a few hours of treatment duration, for example, three to five hours, the liquid in the manure container comprises a solid contents of only approximately 1% or even less.

Due to this short treatment duration, a particularly economic use of the proposed apparatus can reside in that it is not fixedly installed and left unused for an extended period of time adjacent to the manure container but instead, from day to day, is moved to another manure container, for example, by a contractor. The configuration of the apparatus as a movable trailer or the arrangement of the individual components of the apparatus on a movable trailer enables this mobile utilization of the apparatus.

Should the apparatus be installed stationarily, the solid-liquid mixtures can be moved in containers, by means of tanker trucks or the like to the apparatus. For example, by means of a stationarily operated apparatus the solid contents can be separated as completely as possible from the solid-liquid mixture and thermally utilized in a combustion plant that is also stationarily installed thereat. A stationarily configured apparatus is not subject to the limitations to which a mobile apparatus is subjected, for example, with regard to its dimensions, so that stationary apparatuses can be designed to be particularly efficient.

Aside from the regularly mentioned field of application of manure separation, the apparatus can be used in the agricultural field, for example, for fermenter cleaning in that the contents of a biogas fermenter is freed, for example, from mineral solid materials such as sand. In this way, it is avoided that the fermenter slowly fills with sludge and its entire usable volume is made available again by such a cleaning action. The microorganisms which are important for the function of the fermenter are advantageously returned into the fermenter in that the liquid components are recirculated into the fermenter from the apparatus.

Advantageously, it can be provided that the apparatus is not provided with only a single vibration screen but with two vibration screens. In this context, these two vibration screens are arranged in its own housing, respectively. In this connection, it is provided that the solid-liquid mixture is supplied to both housings separately in that a feed line which supplies the solid-liquid mixture to the vibration screens branches and each one of the two housings has its own inlet. By use of two vibration screens, the performance of the apparatus is essentially doubled without having to create a single vibration screen with correspondingly larger, for example, doubled, dimensions, which constructively entails significant challenges. Due to the smaller vibration screens in comparison to such a large vibration screen, the performance of the apparatus can also be cascaded in finer stages and adapted to different needs in that correspondingly two, three or more vibration screens are operated. In particular in stationarily operated apparatuses, this can be provided without problems because here maximal dimensions in regard to type certification for street use must not be taken into account.

The arrangement of two housings and two vibrations screens can be used also advantageously to achieve a particularly high degree of separation in that the two vibration screens have different mesh widths.

By means of a valve arrangement, switching can be enabled in order to supply the solid-liquid mixture selectively to only one of two inlets and thus to only one of the two different vibration screens. For example, the solid-liquid mixture can initially be supplied from the manure tank into the housing in which the vibration screen with greater mesh width is located. Later on, the valve arrangement can be switched so that the solid-liquid mixture which now has already a significantly reduced solid proportion is supplied to the vibration screen with the reduced mesh width so that now further solid materials, unfiltered up to now, can be separated by means of this vibration screen from the solid-liquid mixture. The separation of initially coarser solid components by means of the first large mesh vibration screen prevents that the fine-mesh vibration screen is covered too much by solid components and becomes too little permeable which would negatively affect the throughput capacity.

Moreover, the two differently designed vibration screens with their different mesh widths can be utilized in order to select, in adaptation to the respectively provided starting material, for example, manure types of different compositions, the vibration screen that is best suited, respectively. This can be advantageous in particular in connection with the already mentioned contractors or mobile apparatuses that are to be moved to different sites and are supplied accordingly with possibly very different starting materials.

As an alternative to the mentioned switching of the valve arrangement, the two vibration screens with different mesh widths can be connected in series so that the liquid components of the coarser vibration screen are guided to the finer vibration screen and only thereafter out of the apparatus.

The valve arrangement can however also be designed such that it enables four different operating modes: the solid-liquid mixture is supplied selectively to only one of the two vibration screens, namely selectively, firstly, to one or, secondly, to the other vibration screen; or thirdly, the solid-liquid mixture is supplied in a type of parallel operation to both vibration screens; or fourthly, the solid-liquid mixture in the manner of a serial or sequential operation is supplied first onto one and then onto the other of the two vibration screens. The corresponding configuration of the valve arrangement and they corresponding guiding of pipelines is known to a person of skill in the art, for example, by means of shut-off or switching valves, in particular multi-way valves, and therefore must not be explained in the context of the present proposal in detail.

The solid components that form a filter cake resting on the vibration screen effect a certain sealing of the vibration screen. This sealing action is advantageous inasmuch as the sucking in of air is prevented or reduced which otherwise could be sucked in through the vibration screen where a vibration screen that is extending at a slant upwardly is projecting from the solid-liquid mixture in upward direction. This sealing action by the filter cake therefore enhances the suction performance in the region where the vibration screen is immersed in the solid-liquid mixture and where the liquid is to be sucked from the solid-liquid mixture through the vibration screen in downward direction.

Advantageously, therefore at the leading end of the vibration screen in conveying direction an overflow edge is provided that projects past the vibration screen in upward direction. It effects that a certain minimum layer thickness of the aforementioned filter cake is obtained on the vibration screen and must be maintained before the solid components overcome this overflow edge and can pass from the vibration screen into the discharge opening. The overflow edge can have, for example, a height that amounts to between 0.5 and 3 cm, e.g., approximately 1 cm. Air can therefore be sucked from top to bottom only through the vibration screen, namely only when the filter cake briefly lifts off the vibration screen due to the vibrations.

With the proposed apparatus, at high throughput capacity a high degree of separation can be achieved in that the solid components finally are present with a dry proportion as high as possible, i.e., with a proportion of liquid contained therein as low as possible. However, the apparatus can alternatively be operated such that solid components do not have a dry proportion as high as possible but instead are still liquid and thus can be pumped, should this be advantageous for their further use. The degree of separation can thus be adjusted at will not to be at maximum whereby this is typically connected with an increase of the throughput capacity. For example, with a corresponding configuration of the vibration screen, the separation capacity can be adjusted at will to be minimal so that a filter cake but instead a liquid reaches the outlet opening from the vibration screen which however, in comparison to the supplied solid-liquid mixture, has a higher proportion of solid components. For example, the permeability of the vibration screen can be reduced by a reduced opening proportion, for example, in that a perforated sheet metal is used instead of a screen.

As solid components, the material is referred to which exits from the vibration screen in its conveying direction, reaches the discharge opening, and has a higher solid proportion than the solid-liquid mixture supplied to the apparatus, and in particular has a higher solid proportion than the material which is sucked away transversely through the vibration screen and which is referred to as liquid components.

Also, the so-called solid components can therefore be liquid, for example, can be pumped. In this case, it can be typically provided to not circulate the solid components, for example, back into a manure tank, but into a second container, for example, a tank that is provided stationarily or as part of a tank truck. The proposed apparatus serves in this case for concentrating the solid-liquid mixture in that, as so-called solid components, a flowable material is provided which has a higher solid contents than the originally existing solid-liquid mixture. For example, manure has an economic value that depends on the nutrient contents which in turn is in particular determined by the solid contents. Due to the aforementioned upgrading with solid materials, the value of the obtained solid components that can be discharged as a pumpable liquid fertilizer can be significantly increased in comparison to the originally existing solid-liquid mixture.

Aside from the example of manure processing, a proposed apparatus can also be employed for different separation of solid and liquid components. With the example of manure separation, first practical tests have demonstrated that the quantity of solid components of approximately 7 to 8% can be reduced to significantly less than 1%.

For improving the performance of the apparatus, it can be provided to enable a higher material throughput. For this purpose, a pipe can extend—not illustrated in the drawings—in the interior of the housing, above the slanted screen surface and within the solid-liquid mixture, so as to be oriented horizontally wherein the pipe can extend out of the housing. The pipe comprises in the section which is within the housing penetrations in its wall, similar to a drainage pipe, so that liquid proportion of the solid-liquid mixture can pass into the pipe. The pipe is supplied with the same vacuum that is existing in the housing below the screen surface. Even when with the liquid entering the pipe also solid proportions reach the pipe, the performance of the entire apparatus is still significantly increased. The apparatus is namely connected usually to a large storage container of a solid-liquid mixture and the liquid filtrate which is removed from the apparatus is recirculated to this large storage container so that from this circulation only the solid material is removed that exits from the apparatus. Solid proportions that have reached the aforementioned pipe and are returned into the large storage container are therefore supplied again, earlier or later, to the apparatus. When then already a large proportion of solid materials has been removed from the solid-liquid mixture and the solid-liquid mixture flowing into the apparatus contains a reduced solid proportion, the probability is greater that the solid proportions that have been recirculated now reach the screen surface, are conveyed past the liquid level in upward direction, and in this way are discharged from the circulation as dry material. The described measure for improving the performance serves thus to effect a higher throughput capacity of the apparatus; it thus represents a quantitative improvement.

The improvement of the performance of the apparatus can also be realized in qualitative regard in that the separation of particularly small solid particles from the solid-liquid mixture is enabled, i.e., the purity of the liquid filtrate is increased. Practical tests have shown that the screen surfaces with a mesh width or pore size of 7 μm can be employed which represents an unusually high filter fineness which enables a corresponding very good quality of the liquid that is removed from the solid-liquid mixture—in many applications: water. This qualitative improvement of the apparatus can be enabled in that the screen surface vibrates with a particularly high intensity. For example, a particularly high vibration frequency can be utilized. Taking into consideration the vibration frequency and the vibration amplitude to which the screen surface is exposed or which the screen surface performs, the vibration intensity can be expressed in g (gravitational acceleration). As proposed, the vibration intensity can have values of 7 g or more, in particular of 10 g or more, in particular, for example, values that are lying between 11 g and 13 g, and with which good results have been obtained in practical tests.

The qualitative improvement of the apparatus can also be effected in that the solid-liquid mixture is not only caused to vibrate by the movements of the screen surface itself but is subjected to ultrasound. For example, ultrasound can be oriented from below against the screen surface so that the ultrasound acts on the solid-liquid mixture as well as on the screen surface.

As a result, due to the qualitative improvement of the apparatus, it is effected that deposits of solid materials in front of the pores of the screens are avoided so that, despite the aforementioned filter fineness down to 7 μm, a clogging of the screen surface can be avoided.

A further goal in the further developments of the known apparatus concerns the aspect that the substances that are exiting from the apparatus are sanitized so that they can be stored and/or transported without problem. For example, the disposal of organic hospital waste, in particular when containing human waste, can be highly problematic with regard to hygienic aspects, in particular when in disaster or epidemic regions these wastes contain germs that represent a health hazard. When, for example, in MERS, AIDS, or Ebola-contaminated regions such wastes from hospitals or health clinics reach the regular sewage system—if a sewage system is even present—and the germs contained in these wastes later on reach the environment, the uncontrolled spread of dangerous germs is promoted, despite the efforts of the respective hospitals or health clinics. This problem concerns, on the one hand, regions in which for the disposal of organic wastes typically no sewage system or sewage treatment plants are existing and it concerns regions in which, for example, due to natural disasters, facilities such as a sewage system or sewage treatment plants are destroyed or have become unusable, and this set of problems concerns finally also provisionally erected settlements that are only to be used on an interim basis for a certain duration such as, for example, refugee camps, or settlements with emergency housing in disaster regions. But also independent of whether the organic wastes in epidemic regions contain dangerous pathogenic germs, this set of problems also concerns hospitals in the so-called civilized or highly developed regions in which the set of problems of multi-resistant germs exists. Such germs also should not reach, if at all possible, the environment in an uncontrolled manner.

By means of an apparatus as proposed, the organic wastes that accumulate as solid-liquid mixture can be separated and sanitized. While the sanitized liquid filtrate can be used, for example, for watering purposes or can be disposed of without problem in the sewage system, the solid materials can be supplied to a closed combustion plant. Accordingly, not only the energy contained therein can be utilized by the thermal utilization of the solid materials but also any harmful germs that are possibly contained in the solid materials can be reliably destroyed by the combustion.

The sanitation can be realized, for example, in that the solid-liquid mixture and/or the liquid filtrate is irradiated with UV light. The solid materials can also be irradiated with UV light but here there is the problem that this can be only a supplemental measure because, it is to be expected that the solid materials cannot be penetrated completely by the UV radiation and accordingly cannot be sanitized. The sanitation can be affected alternatively thereto or in addition to a UV irradiation in that the solid-liquid mixture and/or the liquid filtrate and/or the separated solid materials are heated by means of microwaves to a sanitation temperature that is, for example, above 70° or 80°.

The apparatus can advantageously be provided with an aftertreatment unit for the solid material discharged from the apparatus. This aftertreatment unit can be, for example, designed as a packaging unit. For example, the solid material can be pressed to bales that are then wrapped in plastic film by a machine and thus air-tightly packaged. The bales can be embodied, for example, in a generally known way as round bales or can be advantageously formed in a parallelepipedal shape so that they can be stacked in a space-saving way. Or the solid material can be filled into a plastic film whose one end is closed off and which, after filling to a desired hose length, is pinched off and sealed, and optionally cut off from a significantly longer still unfilled hose so that as a result—similar to manufacturing sausages—hose sections are produced which are closed off at both ends and contain the solid material. The aforementioned bales as well as the mentioned hose sections enable subsequently the risk-free storage or the risk-free transport of the packaged solid material so that the latter can be transported, for example, to the aforementioned combustion plant. When the solid material contains a high—and optionally also because of its contained hazardous materials or germs—the thermal utilization in a closed combustion plant can be energetically advantageous and at the same time can ensure that organic ingredients of the solid material can be rendered innocuous. Such closed combustion plants (in contrast to open fire in the open field) are typically provided with powerful filters so that even beyond the thermal action the possibly remaining inorganic harmful particles can be rendered innocuous and cannot reach the environment.

To the housing and to the adjoining so-called hopper into which the solid material is supplied advantageously, several pipelines can be connected in order to be able to supply auxiliary agents.

For example, to the solid material which is flowing through the hopper, sanitation material can be added by means of a pipeline connected to the hopper. Or it is possible to add moisture-absorbing material which affects the mechanical properties of the solid material in order to be able to better press it, for example, in the downstream aftertreatment unit or in order to enable an improved shape stability of the pressed solid material, for example, of the aforementioned bales.

A plurality of pipeline connectors are provided at the end of the apparatus where the screen surface is arranged at the lowest point, i.e., at the so-called inlet end, in which region also the inlet openings are located. In addition, in the region of this inlet end, a lateral pipeline is provided which opens above the screen surface into the housing. Through the pipeline connectors and the pipeline the aforementioned auxiliary agents or processing aids can be supplied into the housing. Since the pipeline is arranged higher than the pipeline connectors, the behavior or the effect of the respectively supplied material can be affected. In addition, in the conveying direction of the screen surface, further pipelines or pipeline connectors can be provided so that, at a future point in time during the separation process within the housing, substances can still be added to the solid-liquid mixture in its initial composition or with increasing solid contents. The arrangement of the screen surface is apparent from a double row of bores that serves for attaching the screen surface and indicates the slanted extension of the screen surface in comparison to the horizontal.

Via outlet lines, the liquid filtrate is removed from the housing of the apparatus.

The solid materials can be either packaged air-tightly, as already explained above, or they can be compressed at least so strongly that they form a closure plug that seals the space that is enclosed by the housing and by the hopper.

When for reasons of health harmlessness no air-tight wrapping of the solid materials is provided, a screw press as an aftertreatment unit can adjoin the hopper. The aforementioned closed-wall pipeline can be designed for this purpose as a transition member whose cross section passes from a rectangular to a circular contour so that the screw press with its circular tubular housing can adjoin it. At the end of the screw press, the material that is innocuous regarding health can reach the environment and, for example, can be deposited on the cargo platform of a vehicle or the cargo space of a vehicle or can be deposited as a pile on site.

However, when an air-tight wrap of the solid material is provided, by means of the aforementioned plug that is formed by the screw press it can be ensured that for a subsequent portioning of the solid materials, for example, in order to produce the aforementioned bales or to fill the plastic film hose, no air from the exterior can enter the region of the apparatus in which a vacuum is to be maintained.

An embodiment of the invention will be explained with the aid of the purely schematic illustrations in the following in more detail. It is shown in:

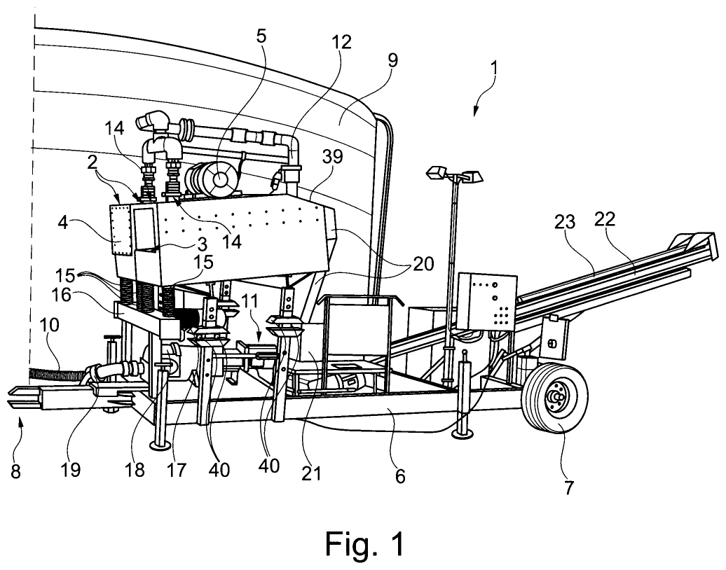

FIG. 1 a perspective view of an apparatus for separating manure;

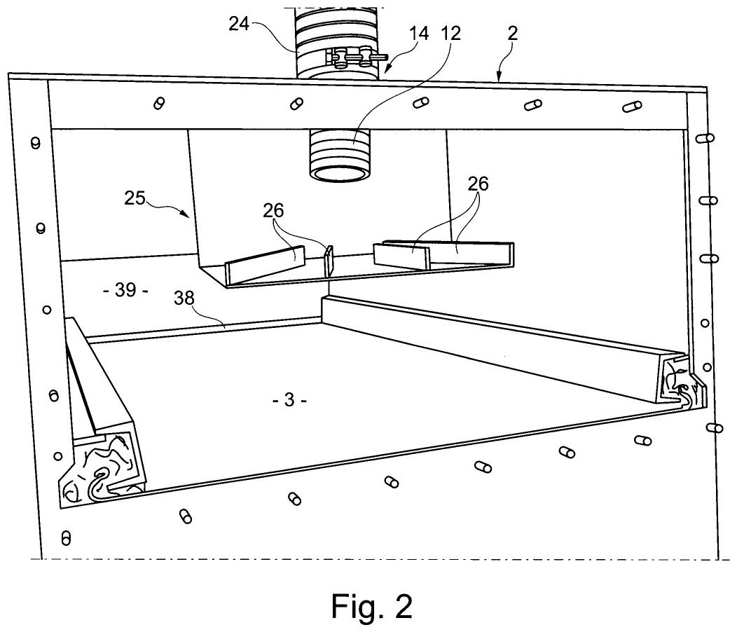

FIG. 2 a view of a housing of the apparatus of FIG. 1, together with the vibration screen located therein;

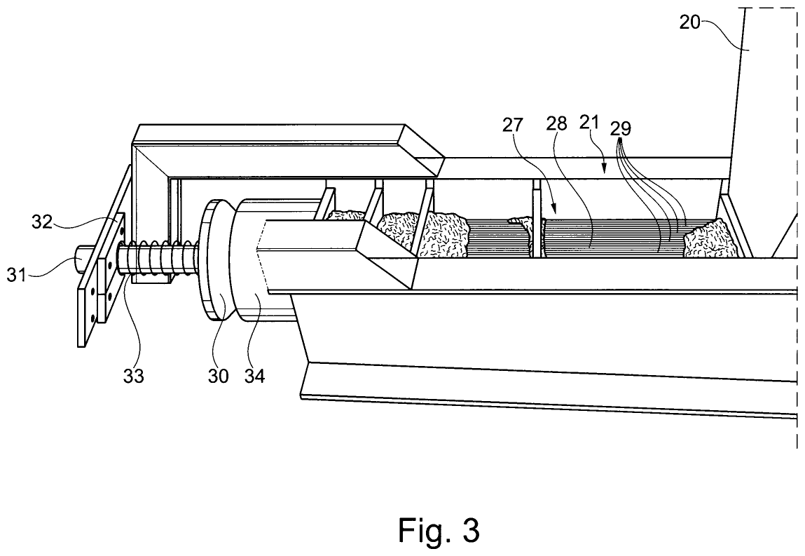

FIG. 3 a perspective view of an open screw press of the apparatus of FIG. 1;

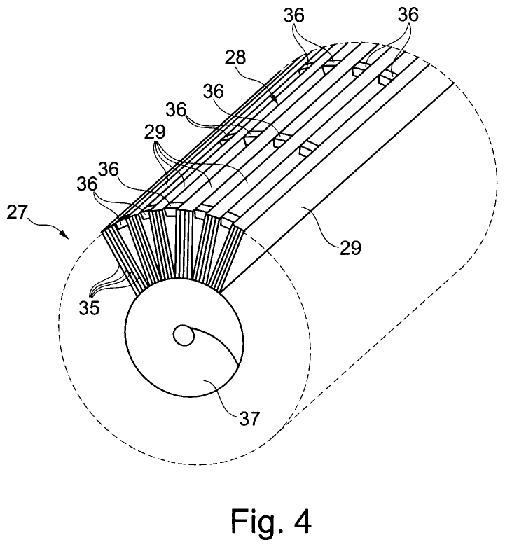

FIG. 4 a view in a different perspective of the screw press of FIG. 3;

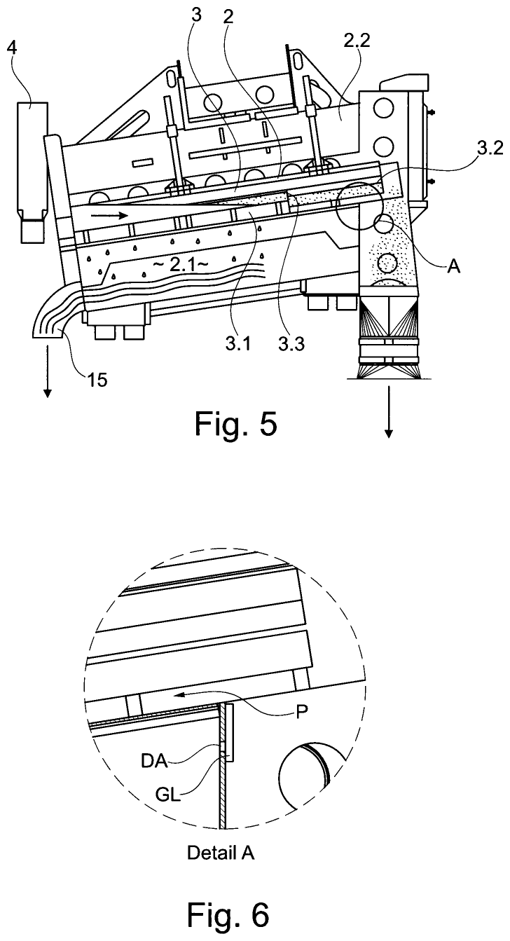

FIG. 5 a sectioned cross section illustration of the embodiment of FIG. 1 in the region of a stepped screen surface of a vibration screen and a pressure compensation between the space below the vibration screen and the space above the vibration screen;

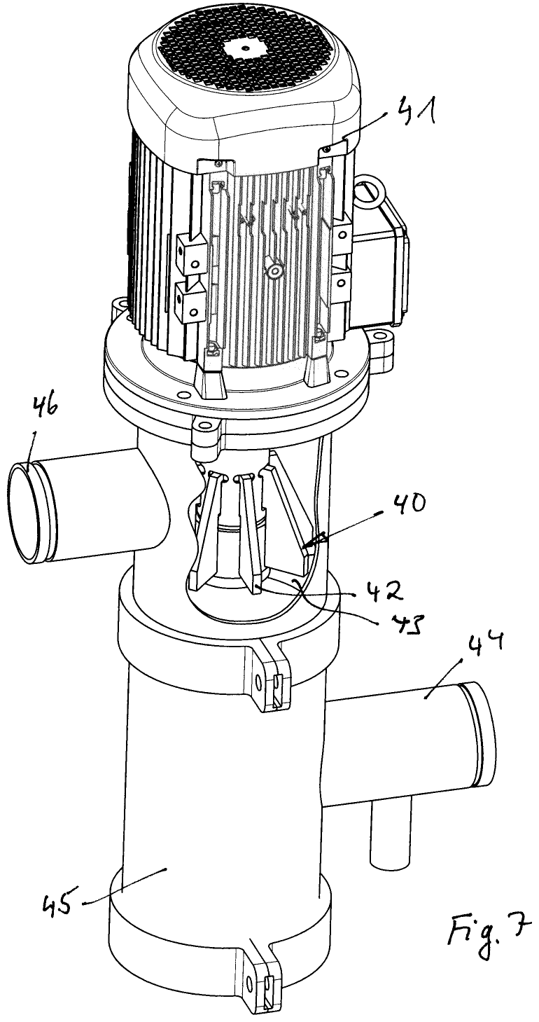

FIG. 6 the detail A in enlarged illustration;

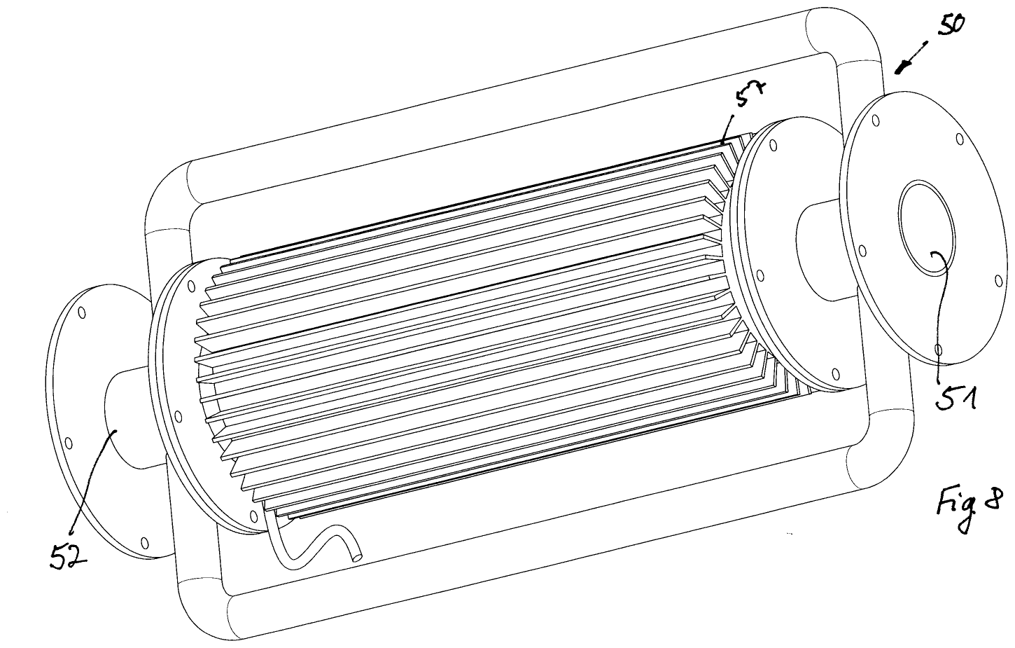

FIG. 7 in an individual illustration, a rotating cutting mechanism that can be driven by a motor, which is connectable about an inlet and an outlet in the liquid flow of the solid-liquid mixture as a second or only hydrodynamic reactor;

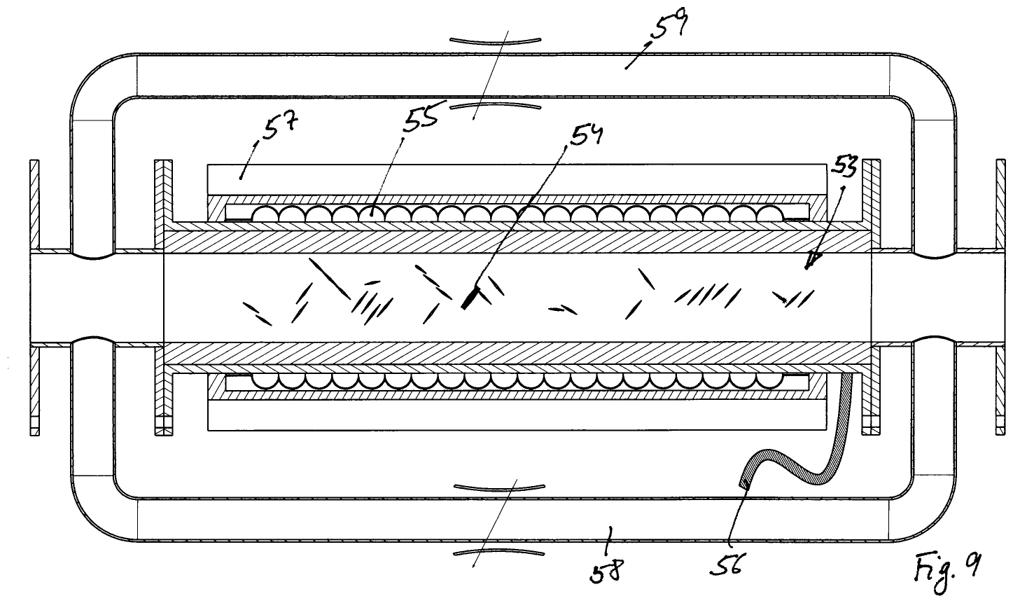

FIG. 8 in a side view (also perspective) an embodiment of a hydrodynamic reactor with cooling ribs and a magnetic rotary field as well as with ferromagnetic needles;

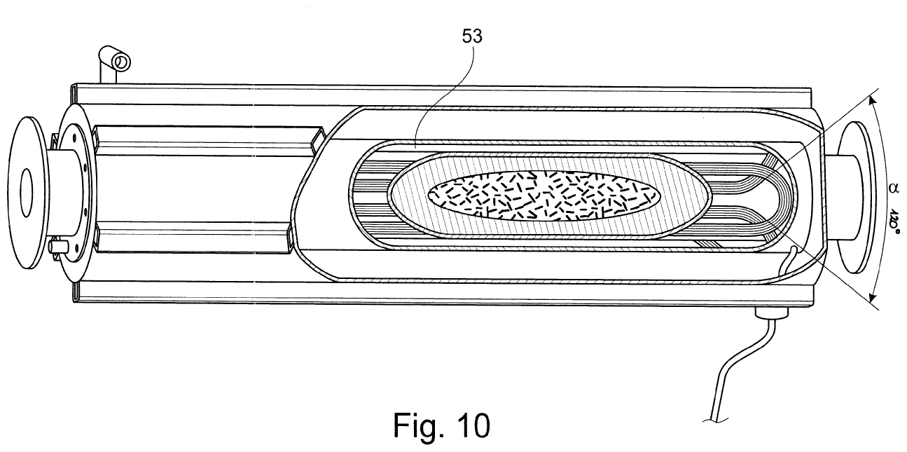

FIG. 9 a cross section illustration of the embodiment according to FIG. 8; and

FIG. 10 a partially broken-away embodiment according to FIG. 8 with the arrangement of conductor loops with a 120° winding offset.

In the drawings, an apparatus is referenced as a whole by 1 which serves for separating solid and liquid components of a solid-liquid mixture, in particular manure. The apparatus 1 comprises two housings 2 which are combined to a common component group in which a vibration screen 3 is arranged, respectively, that is positioned at a slant relative to the horizontal. In the housing 2 to the left or to the rear in FIG. 1 an end wall 4 is mounted which in the housing 2 to the right or facing the viewer has been removed. At the top side of this component group, i.e., of the two housings 2, a vibration drive 5 is mounted.

The apparatus 1 is embodied as a mobile apparatus in the form of truck trailer, with a frame 6, wheels 7, and a drawbar 8 that by means of a trailer coupling can be connected to a tractor vehicle. By vibration dampers in the form of elastomer bearings 40, the housings 2 are decoupled from the frame 6 with regard to vibrations.

This mobile apparatus 1 is illustrated in FIG. 1 in front of a manure tank 9. A corrugated pipe 10 supplies manure as solid-liquid mixture from the manure tank 9 to the apparatus 1, i.e., to a pump 11 provided thereat. From the pump 11, the solid-liquid mixture passes through a pipeline 12 to the two housings 2, wherein the pipeline 12 branches and extends to two inlets 14 of which each one opens into one of the housings 2.

The liquid components which pass through the vibration screens 3 exit through outlets 15 from the housing 2. At the bottom side of each housing 2, two outlets 15 are provided, respectively. The outlets 15 open into a collecting pipe 16 which is designed as a transversely positioned square pipe. From the collecting pipe 16, the liquid components are supplied through a suction line 17 to a suction pump 18. From the suction pump 18 they pass through a return line 19, which is designed as a hose, back into the manure tank 9.

The vibration screens 3 and, in the illustrated embodiment, the two housings 2 are arranged at a slant relative to the horizontal. The conveying direction of the vibration screens 3 extends in this context according to FIG. 1 from the left to the right so that the right end of a vibration screen 3 is arranged higher than the left lower end of the vibration screen 3. The level of the solid-liquid mixture within a housing 2 is adjusted in operation of the apparatus 1 such that the vibration screen 3 with its leading right end, viewed in the conveying direction, projects from the solid-liquid mixture in upward direction.

The solid components pass on the vibration screen 3 to the right end of the housing 2 and from there pass through an outlet opening into a hopper 20 which tapers in downward direction. In parallel operation of the two vibration screens 3, when namely the solid-liquid mixture is supplied through the pipeline 12 uniformly to both housings 2, the solid components pass from both housings 2 into the hopper 20 and from there in downward direction into a collecting chamber 21.

From the collecting chamber 21, the solid components are conveyed away by means of a screw conveyor 22. Due to the permissible maximum length which the apparatus 1 may have as a vehicle trailer, the screw conveyor 22 is configured in divided form and the end illustrated to the right in FIG. 1 represents a connecting region. An extension member 23 of the screw conveyor 22 can extend from there the screw conveyor 22 past the illustrated right end to a greater length and a greater height. In the illustrated embodiment, a foldable or collapsible configuration of the screw conveyor 22 is provided wherein the extension member 23 remains connected moveable by a hinge about an upright axis to the fixedly mounted part of the screw conveyor 22 and from an illustrated folded position can be pivoted into an extended position in which it extends in a straight line the fixedly mounted part of the screw conveyor 22. In FIG. 1, only the outer envelope pipe of the screw conveyor 22 including the extension member 23 is illustrated; the actual screw extends within this envelope pipe, as is generally known.

FIG. 2 shows a view of the right or front housing 2 of the apparatus 1 of FIG. 1 where the end wall 4 has been removed. The pipeline 12 extends in the region of the inlet 14 into the housing 2. A guide socket 24 is provided on the housing 2 though which pipeline 12 extends so that in this way the pipeline 12 is decoupled from the housing 2 with regard to vibrations and can remain comparatively rigid while the housing 2 together with the vibration screen 3 is caused to vibrate by the vibration drive 5.

Entry of air into the housing 2 is possible firstly as needed by an annular gap that is provided between the guide socket 24 and the pipeline 12 which is thinner here, inasmuch as this annular gap is not sealed which however can be advantageously provided in a generally known manner. Secondly—and optionally as a single location—entry of air is possible in the region of the outlet opening where namely the hopper 20 adjoins the housing 2. In other respects, the housing 2 is closed. The aforementioned entry of air is realized due to the suction action of the suction pump 18 which produces a vacuum in the housing 2.

The overflow edge 38 is provided in the conveying direction at the front on the vibration screen 3, in front of the discharge opening, so that the solid components are retained on the vibration screen 3 and must reach a corresponding height or layer thickness before they overcome the overflow edge 38 and can pass into the discharge opening.

Below the inlet 14, a distributor 25 is provided which is designed as a flat sheet metal which substantially extends transverse below the inlet 14 and which has several distribution ribs 26 which distribute the solid-liquid mixture, flowing via the inlet 14 into the housing 2, across the entire width of the vibration screen 3.

While in the housing 2 the end wall 4 facing the viewer is removed and allows a view of the vibration screen 3 and of the distributor 25, FIG. 2 shows an end wall 39 which is positioned opposite the removed end wall 4 and which, in comparison to the end wall 4, is arranged to lie more flat and above the hopper 20.

FIG. 3 shows a possibility of how the collecting space 21 in the illustrated embodiment can be configured. From the hopper 20, the solid components of the solid-liquid mixture pass from the housing 2 into the collecting space 21. The collecting space 21 is designed as a downwardly open housing in which a screw press 27 is operating. In this case also, the actual screw, i.e., the pressing screw, cannot be seen but instead a filter 28 can be seen.

FIG. 4 shows schematically the configuration of the screw press 27. The filter 28 is formed by a plurality of flat irons 35 which extend in longitudinal direction of the screw press 27 and which are combined to packages 29, respectively.

Each package 29 comprises in this context a plurality of upright oriented flat irons 35, for example, between two and ten pieces, wherein, purely as an example, in the illustrated embodiment four flat irons 35 form a package 29, respectively. The packages 29 are arranged such that with their radial inwardly positioned longitudinal edges they adjoin each other while between two neighboring packages 29, at the radial outer circumference of the filter 28, a gap extends in the longitudinal direction of the screw press 27 because the flat irons 35 within a package 29 are parallel to each other and contact each other across the entire surface. Spacers 36 are provided between the individual packages 29.

The packages 29 surround a pressing screw 37 similar to an envelope pipe which is slotted in longitudinal direction. In FIG. 4, the filter 28 adjoins almost the outer circumference of a pressing screw wherein however a small gap between the filter 28 and the pressing screw 37 is provided in order to enable a low-wear operation of the screw press 27. In deviation from this embodiment, a significantly larger gap between the filter 28 and the pressing screw 37 can be provided should this be advantageous for the treatment of the material to be processed, respectively.

The end of the screw press 27 which is leading in conveying direction and illustrated to the left in FIG. 3 is closed by a conical plug 30 which is guided by means of a bolt 31 in an abutment 32. A pressure spring 33 is supported at the abutment 32 which holds the conical plug 30 in its closed position in which it is contacting the leading end face of an envelope pipe 34 which surrounds, adjoining the filter 28, the pressing screw 37.

When operation of the screw press 27 is started, the conical plug 30 initially contacts the envelope pipe 34 and closes it off. By the pressing pressure which is built up in the interior of the screw press 27 by the rotation of the pressing screw 37, moisture is driven out of the solid components and pressed through the filter 28. Upon reaching a satisfactorily high pressing pressure the compressed solid components can push the conical plug 30 away from the envelope pipe 34 against the action of the pressure spring 33 so that now the separated material, i.e., the solid components, exit from the annular gap between the conical plug 30 and the envelope pipe 34 and can drop down. Here, they are caught by the screw conveyor 22.

As an alternative to the described embodiment, it can be provided to configure the collecting space 21 simply as a container, i.e., as an empty space without a screw press 27 mounted therein. The screw press 27 in this case can be operated as a separate unit, for example, only as needed when the solid components separated initially by means of the vibration screen 3 are supposed to have an even higher solid or dry proportion. For example, in this case the material can be conveyed by the screw conveyor 22 out of the collecting space 21 to the screw press 27. Depending on which type of further processing is provided for the separated solid components, an aftertreatment of the solid components coming from the vibration screen 3 by means of the screw press 27 can be realized or can be omitted.

In FIG. 5, in a cross section illustration the vibration screen 3 is illustrated in more detail in an embodiment with two vibration screen regions 3.1 and 3.2 in the conveying direction which are designed in a stepped configuration so that between the vibration screen regions 3.1 and 3.2 a break edge 3.3 is provided and the surface of the vibration screen region 3.2 extends at a height distance to the surface of the vibration screen region 3.1 and, as a whole, is positioned lower. In this way, it happens that, during conveying of the solid-liquid mixture in conveying direction in the region of the stepped configuration and thus in the region of the break edge, a turning process in the meaning of an overhead turning of the supplied liquid-solid material occurs so that the material that is initially at the top now comes to rest below the upper surface directly on the screen surface of the second screen surface region 3.2, whereby the degree of separation is further enhanced.

Moreover, between the lower housing space 2.1 and the upper housing space 2.2 a pressure compensation according to the direction of arrow P in FIG. 6 takes place because, by means of the rubber lip GL in FIG. 6, a pressure compensation between these two spaces can be automatically realized. Due to the elasticity of the rubber lip, this pressure compensation can be realized in that it lifts off and permits an air circulation due to the openings provided thereat. This prevents that the meshes of the screen surfaces of the vibration screens become clogged, and it is thus always ensured that a functional operation during the separation process is provided.

In FIG. 7, an embodiment of a hydrodynamic reactor is illustrated in the form of a cutting mechanism 40 that is driven by a motor 41 and comprises cutting knives 42 with a corresponding counter blade 43. The cutting knives 42 are driven in rotation by the motor 41. By means of the connector pipe 44 a liquid to be purified is supplied wherein solid particles can collect in the pipe region 45. After a corresponding deflection, the cutting knives 42 process the liquid to be cleaned which is then flowing out through the outlet 46 from this reactor 40, optionally for further treatment.

In FIG. 8, another hydrodynamic reactor is illustrated in the form of a reactor 50 to be provided with an electromagnetic rotary field that has inlet opening 51 and an outlet 52 and comprising an inner chamber 53 (FIGS. 9 and 10) in which the magnetizable needles 54 or blades 54 are arranged. This inner reaction chamber 53 is provided with a winding of electrical conductors 55 which are connected to a current source 56. Moreover, on the outer wall cooling ribs 57 are provided. Bypass lines 58 and 59 are also provided.

As can be seen in more detail in FIG. 10, the conductor loops of the winding of the conductors 55 are provided such that an angle a of 120° between inlet and outlet is present on the outer circumference of the reaction chamber 55. In this way, per 160° three inlets and three outlets are provided whereby it can be achieved that the magnetizable needles or blades 54 rotate in such an arrangement within the reaction chamber that they work in ordered orientation as rotating ring in the chamber 53, whereby very excellent results in the liquid can be obtained.

What is claimed is:

1. A method for cleaning and/or disinfecting a liquid and/or aqueous medium, comprising the following method steps:
cavitation treatment of the medium, in particular with jet cavitation, at a vacuum of <1 bar;
subsequent treatment of the medium in a hydrodynamic reactor with a magnetic rotary field and magnetic and/or magnetizable elements, in particular with ferromagnetic needles and/or with a rotating cutting mechanism with rotating cutting knives at a vacuum of <1 bar;
subsequent separation, in particular sedimentation, of the treated medium with a sludge separation at a vacuum of <1 bar.

2. The method according to claim 1, further comprising performing the treatment with jet cavitation in the hydrodynamic reactor under formation of strong oxidation agents OH, H₂O₂, and O₃.

3. The method according to claim 1, further comprising performing the treatment in the hydrodynamic reactor with dispersion of particles to submicron dimensions and enlargement of the phase boundary surface gas-liquid-solid.

4. The method according to claim 1, further comprising performing an equalization of the aqueous medium prior to the cavitation treatment.

5. The method according to claim 1, further comprising adding during the course of the treatment in the hydrodynamic reactor at least one reagent selected from the group consisting of: lime milk, aluminum sulfate, iron chloride, and combinations thereof.

6. The method according to claim 1, further comprising additionally treating the obtained medium in a rotating impulse device.

7. The method according to claim 1, further comprising additionally filtering the medium in a deep-bed filter.

8. The method according to claim 1, further comprising additionally ozone-treating the medium.

9. The method according to claim 1, further comprising additionally treating the medium with a UV radiation.

10. The method according to claim 1, further comprising performing a separation of solid and liquid components of a solid-liquid mixture to obtain the medium to be subjected to the cavitation treatment, wherein the separation comprises applying the solid-liquid mixture via an inlet (14) onto a vibration conveying device arranged in a substantially closed housing (2) and comprising a vibration screen (3), generating inside the housing, in a space above and below the vibration screen, a negative pressure (vacuum) relative to the ambient pressure of the housing, and applying, inside the housing (2), in the space (2.1) below the vibration screen (3), a negative pressure (vacuum) relative to the ambient pressure compared to the space (2.2) above the vibration screen.

11. The method according to claim 10, wherein within the housing (2) in the space (2.1) below the vibration screen (3) and in the space (2.2) above the vibration screen (3) a negative pressure of <1 bar is applied.

12. The method according to claim 11, wherein inside the housing (2) in the space (2.1) below the vibration screen (3) a negative pressure of −0.3 bar to −0.8 bar and in the space above the vibration screen (3) a negative pressure of −0.2 to −0.6 bar is applied.

13. The method according to claim 10, further comprising performing a pressure compensation between the space (2.1) below the vibration screen (3) and the space (2.2) above the vibration screen (3).

14. The method according to claim 13, further comprising performing the pressure compensation automatically.

15. The method according to claim 13, further comprising carrying out the pressure compensation at the at an end region of the vibration screen (3) in the housing (2), said end region arranged oppositely positioned to a region of the vibration screen (3) where the solid-liquid mixture is supplied to the vibration screen (3).

16. The method according to claim 13, further comprising adjusting the level of the solid-liquid mixture so high that the vibration screen (3) projects partially past said level in upward direction and that the pressure compensation is carried out in a region in which the vibration screen (3) projects past said level.

17. The method according to claim 10, further comprising conveying the solid-liquid mixture across the vibration screen (3) such that the solid-liquid mixture undergoes a turning process during the course of conveying across the vibration screen (3).

18. The method according to claim 17, wherein the solid-liquid mixture performs an overhead turning movement in the turning process during the course of conveying across the vibration screen (3).

19. The method according to claim 10, further comprising adjusting a vibration of the vibration screen (3) such that the solid-liquid mixture during the separation is maintained in flotation state above the vibrating vibration screen (3).

20. The method according to claim 10, further comprising supplying the solid components separated from the solid-liquid mixture to a hydrothermal carbonization.

21. The method according to claim 10, further comprising subjecting the solid-liquid mixture and/or the separated solid proportions and/or the separated liquid to be discharged to a UV treatment and/or an ultrasound treatment.

22. The method according to claim 10, further comprising detecting the negative pressure prevailing in the housing (2) below and/or above the vibration screen (3) by pressure sensing devices and supplying the detected measured values to a measured value processing device and, as a function of the measured value result, controlling at least one pressure generator to adjust process-specific pressure parameters according to the process parameters.

23. An apparatus for performing the method according to claim 1, the apparatus comprising:
a cavitation treatment device operating at a vacuum of <1 bar;
a hydrodynamic reactor, arranged downstream of the cavitation treatment device, with a magnetic rotary field and magnetic and/or magnetizable elements, in particular with ferromagnetic needles and/or with a rotating cutting mechanism with rotating cutting knives, operating at a vacuum of <1 bar;
a separation device, in particular sedimentation device, arranged downstream of the hydrodynamic reactor, with a sludge separation operating at a vacuum of <1 bar.

24. An apparatus for disinfecting and cleaning aqueous media for performing a method according to claim 1, wherein the apparatus comprises the following:
a cavitator embodied in particular as a jet cavitator which is provided with elements for injecting air or oxygen-air mixture;
a hydrodynamic reactor with magnetic rotary field and with magnetic and/or magnetizable elements, in particular with ferromagnetic needles;
a unit for separating, in particular for sedimentation, preferably combined with a sludge separating apparatus.

25. The apparatus according to claim 24, further comprising an equalization mixer which is installed in flow direction upstream of the jet cavitator.

26. The apparatus according to claim 24, further comprising a device for metering reagents for the hydrodynamic reactor.

27. The apparatus according to claim 24, wherein the unit for sedimentation of the medium is provided with hydrocyclones.

28. The apparatus according to claim 24, further comprising a rotating impulse device which, in flow direction, is installed downstream of the unit for sedimentation.

29. The apparatus according to claim 24, further comprising deep-bed filters which, in flow direction, are installed downstream of the unit for sedimentation.

30. The apparatus according to claim 24, further comprising a unit for ozone treatment of the medium which, in flow direction, is installed downstream of the unit for sedimentation.

31. The apparatus according to claim 24, further comprising a unit for a UV irradiation of the medium which, in flow direction, is installed downstream of the unit for sedimentation.

32. The apparatus according to claim 24, further comprising an automatic control unit for controlling the processes.

33. The apparatus according to claim 24, wherein the hydrodynamic reactor is furnished with electric conductors configured to create the magnetic rotary field, wherein the electrical conductors comprise conductor loops in a 120° pattern (inlet/outlet).
